(19) United States
(12) Patent Application Publication
(10) Pub. No.: US 2016/0221460 A1
(43) Pub. Date: Aug. 4, 2016

(54) CHARGING PLUG FOR AN ELECTRICALLY DRIVEN VEHICLE

(71) Applicant: Dr. Ing. h.c. F. Porsche Aktiengesellschaft, Stuttgart (DE)

(72) Inventor: Daniel Spesser, Illingen (DE)

(21) Appl. No.: 15/006,248

(22) Filed: Jan. 26, 2016

(30) Foreign Application Priority Data
Jan. 29, 2015 (DE) 10 2015 101 284.7

(51) Int. Cl. B60L 11/18

(52) U.S. Cl. CPC B60L 11/1818; B60L 11/1838; B60L 11/1874

(57) ABSTRACT

A charging plug for an electrically driven vehicle has a feed line for electrically connecting the charging plug (10) to a charging infrastructure, power contacts and a signal contact for electrically connecting the charging plug (10) to the vehicle. A rectifier (12) is connected to the feed line and to the power contacts for converting an alternating current obtained by the feed line into a direct current that is delivered by the power contacts in a charging process. A control and protection device (14) is connected to the feed line, to the power contacts and to the signal contact for matching the charging process to the vehicle by means of the signal contact.

### CROSS REFERENCE TO RELATED APPLICATION

This application claims priority under 35 USC 119 to German Patent Appl. No. 10 2015 101 284.7 filed on Jan. 29, 2015, the entire disclosure of which is incorporated herein by reference.

### BACKGROUND

1. Field of the Invention

The invention relates to a charging plug for an electrically driven vehicle.

2. Description of the Related Art

Apparatuses for charging the traction battery of an electrically driven vehicle have long been known. The traction battery can be connected to the stationary alternating-current supply system that forms part of the public infrastructure by means of a vehicle-end charging device via a charging cable. To this end, the charging cable has a charging plug that can be plugged into a vehicle-end charging socket. The vehicle-end charging device comprises a rectifier, also called an AC/DC converter that sets the maximum possible charging current using a control and protection device (in-cable control and protection device, IC-CPD) in the form of a box in the cable.

DE 10 2009 045 639 A1 relates to an electrical connecting apparatus comprising an output connection that is connectable in a detachable manner to a charging connection of a rechargeable battery device of a vehicle which is operated by current. The electrical connecting apparatus comprises a supply connection designed to be connected in a detachable manner to a supply system connection of an alternating-current low-voltage integrated supply system, and comprising an AC/DC converter that is suitable for converting the AC voltage of the supply connection into an electrical DC voltag suitable for the rechargeable battery apparatus.

DE 10 2010 062 234 A1 discloses a plug arrangement with a housing that has an inlet for receiving an electrical cable harness and an outlet for engaging into a vehicle socket for electrically charging a vehicle. The housing comprises a large number of transversely running retaining ribs, a pivot point and a series of guides. The housing is designed to hold a distributed load. A locking mechanism comprising a lever, a connecting part and a tripping means is fit to the outside of the housing for selectively connecting the housing to the vehicle socket. The lever is connected to the pivot point in a pivotable manner, and the connecting part is coupled to the lever to pivot the lever. The tripping means is mounted in a displaceable manner and comprises openings dimensioned to receive the respective guides. The tripping means operates the connecting part. A shell is arranged over the housing to hold the locking mechanism and to allow the locking mechanism to be repaired and/or replaced without electronic components in the housing being exposed for this purpose.

EP 2 615 743 A1, JP 2012-230851 A, WO 2014/036013 A2 and EP 2 641 782 A1 propose similar arrangements.

### SUMMARY

The invention provides a charging plug for an electrically driven vehicle. The charging plug jointly integrates the vehicle-end charging device, in particular the vehicle-end AC/DC converter, and the monitoring and control device, which is usually in the form of a box in the cable, in the charging plug of the charging cable.

One advantage of this invention is that the vehicle-end charging device is dispensed with, thereby reducing the weight of the vehicle. The charging cable also is easier to handle by not arranging the monitoring and control device as a box in the charging cable. Finally, the vehicle is provided with the charging energy, without further line losses, in the form of the direct current that is required for charging the traction battery.

Further advantageous refinements of the invention are specified in the dependent patent claims.

An exemplary embodiment of the invention is illustrated in the drawing and will be described in greater detail in the text that follows.

### BRIEF DESCRIPTION OF THE DRAWING

FIG. 1 is a block diagram of a charging plug according to an embodiment of the invention.

### DETAILED DESCRIPTION

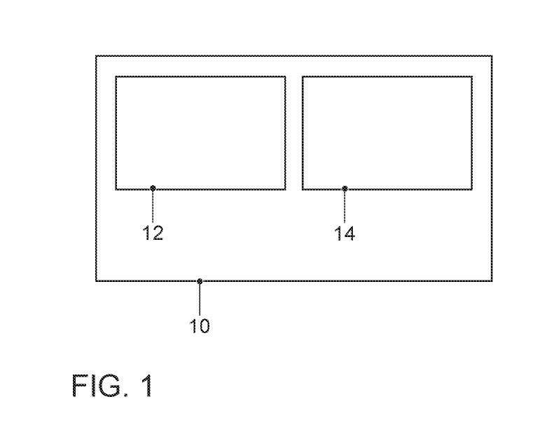

FIG. 1 illustrates a charging plug 10 that integrates a rectifier 12 and a control and protection device 14 in the charging plug 10. A feed line connects the charging plug 10 electrically to the charging infrastructure, while power contacts and a signal contact are provided for electrically connecting the charging plug 10 to the vehicle. For the sake of simplicity, the figure does not show the last-mentioned features in any detail.

As part of the charging process, the alternating current that is obtained by the feed line is converted into alternating current by the highly integrated electronics of the rectifier 12 and delivered to the vehicle by the power contacts. The control and protection device 14 is connected to the feed line, to the power contacts and to the signal contact at the same time, and matches the charging process to the vehicle by means of the signal contact. In the process, the charging plug 10 fulfills a range of software and hardware functions that are implemented by a first module for evaluating the integral of the previous charging powers, a second module for evaluating the coolant temperature, a third module for evaluating the energy throughput, a fourth module for detecting the outside temperature, a fifth module for detecting the internal device temperatures, a sixth module for detecting and evaluating the existing power of the respective power paths, a seventh module for detecting the existing current and voltage loadings of all semiconductors and transformers, an eighth module for the interface for the charging management system for the power increase recommendation, and a ninth module for the CP preparation.

A characteristic shape of the cooling ribs and also the design and location of the handle give the charging plug 10 an esthetically pleasing and functional character.

What is claimed is:

1. A charging plug for an electrically driven vehicle, comprising:
a feed line for electrically connecting the charging plug to a charging infrastructure;
power contacts and a signal contact for electrically connecting the charging plug to the vehicle;
a rectifier connected to the feed line and to the power contacts, for converting an alternating current that is obtained by the feed line into a direct current that is delivered by the power contacts in a charging process; and
a control and protection device connected to the feed line, to the power contacts and to the signal contact, for matching the charging process to the vehicle by means of the signal contact.

2. The charging plug of claim 1, further comprising a first module for evaluating an integral of a previous charging power.

3. The charging plug of claim 2, further comprising a second module for evaluating a coolant temperature.

4. The charging plug of claim 3, further comprising characterized by a third module for evaluating an energy throughput.

5. The charging plug of claim 4, further comprising a fourth module for detecting an outside temperature.

6. The charging plug of claim 5, further comprising a fifth module for detecting internal device temperatures.

7. The charging plug of claim 6, further comprising a sixth module for detecting and evaluating an existing power of a respective power path.

8. The charging plug of claim 7, further comprising a seventh module for detecting an existing current or voltage loading of semiconductors and transformers.

9. The charging plug of claim 8, further comprising an eighth module for outputting a power increase recommendation to a charging management system.

10. The charging plug of claim 9, further comprising a ninth module for preparing control data for the signal contact.
